(19) United States
(12) Patent Application Publication
(10) Pub. No.: US 2006/0124251 A1
(43) Pub. Date: Jun. 15, 2006

(54) Outer door for small spaces

(76) Inventor: Timothy L. Brown, Newport News, VA (US)

Correspondence Address: GREENBERG & LIEBERMAN, LLC, 2141 WISCONSIN AVE, N.W., SUITE C-2, WASHINGTON, DC, 20007, US

(21) Appl. No.: 11/008,319

(22) Filed: Dec. 9, 2004

(51) Int. Cl. E06B 3/32

(52) U.S. Cl. 160/90

(57) ABSTRACT

An outer door designed to open outward where the space to open outward is severely restricted. The top of the outer door rotates upward about a horizontal axis as the bottom of the outer door rotates about a vertical axis. A cross bar fixedly attached to the bottom of the outer door pulls the top of the outer door via at least one spring so that the outward motion of the bottom of the outer door lifts the top of the outer door, and then allows the top of the outer door to become vertical again when the bottom of the outer door is returned to the entryway in a closed position.

### FIELD OF THE INVENTION

The present invention is a modified screen or glass door. More specifically, the present invention is a two-piece door having a bottom door that opens normally about a vertical axis, and additionally, having a top door that opens on a different hinge about a horizontal axis.

### BACKGROUND OF THE PRESENT INVENTION

Screen doors and glass doors are fairly common addition to door that provide entryways into homes. Conventional wisdom teaches that screen doors and glass doors provide better insulation than an entryway door alone, as another door simply provides an extra layer of protection from the outside elements. Moreover, screen doors and glass doors can serve as a window of sorts, as fresh air and light will enter via a screen door or glass door when the entryway door is left ajar.

Typical entryway doors are mounted to a doorframe so that they swing inward, toward the inside of a structure. Typical screen doors and glass doors, in contrast, are mounted to a doorframe so that they swing outward, away from the inside of structure. In terms of practicality, it makes sense that the user would open the screen door or glass door first, when entering the structure, so would want pull it open for access to the entryway door; that is, opening the entryway door if the glass door or screen door pushed open toward the entryway door would make access to the entryway hard, if not impossible. Further, the threshold of the structure would most likely prevent a screen door or glass door from opening inward toward the entryway door.

While screen doors and glass doors are desirable, they are impossible to install in areas where the space outside an entryway door is severely limited. For example, an entryway from a garage into a dwelling might well have a lower than normal ceiling to accommodate an above-garage room. In such case, the lower ceiling typically is raised near an entryway, but only enough so that the user can ascend a few steps from the garage to the entryway without hitting the user's head in the ceiling. Yet, while the raised ceiling near an entryway accommodates the user in such fashion, the raised ceiling does not accommodate a screen door or glass door swinging outward from the entryway. In fact, unless the raised ceiling is extended, it is impossible to install a screen door or glass door in the entryway whatsoever. Extending the raised ceiling is undesirable, though, any extension of the raised ceiling will encroach upon the above-garage room.

Thus, there is a need for an apparatus that facilitates screen door or glass door installation at an entryway from a garage into a dwelling, when the garage has a lower than normal ceiling. Specifically, there is a need for an apparatus that allows a screen door or glass door to swing outward and away from the entryway as would a conventional screen door or glass door, while still not disturbing the lower ceiling in the garage.

U.S. Pat. No. 4,094,099 issued to Birch on Jun. 13, 1978, shows a screen door assembly for a camper. While Birch's device is a remedy for a screen door opening and closing in tight confines, in is truly meant for a camper. Unlike the present invention, Birch's device does not have a two-section door wherein one of the sections opens out and away from the entryway. Further, unlike the present invention, Birch's device does not have a two-section door wherein one of the sections opens on a vertical axis while the other section opens on a horizontal axis.

Thus, there exists a need for a screen door or glass door that can open as does a normal screen door or glass door, while at the same time, not interfering with a lower than normal ceiling outside the entryway.

### SUMMARY OF THE INVENTION

The present invention is a two piece screen door or glass door which operates much like a conventional screen door or glass door. Just as a conventional screen door or glass door will open out from the entryway, so does the present invention.

A first piece of the present invention opens along a vertical plane—just as would a conventional screen door or glass door. A second piece of the present invention opens along a horizontal plane—very much unlike a conventional screen door or glass door. The first piece of the present invention is opened, and as it continues to open, it lifts the second piece of the present invention up. At its fully extended position, the present invention has its first piece positioned 90 degrees away from the entryway. At its fully extended position, the present invention has its second piece positioned roughly 45 degrees from the entryway. The 45 degree positioning is roughly coincides with the 45 degree slope of stairs conventionally ascending to the entryway.

The 45 degree positioning is necessary because typical entrances from a garage with a lower than normal ceiling have a stairwell leading up to the entryway. While there is oftentimes enough clearance for the user to ascend the stairwell and enter the entryway, a screen or glass door opening outward from the entryway needs its own clearance. A typical screen or glass door will not be able to fully open because it will contact the lower than normal ceiling.

Thus, with the present invention, the user is able to swing open the first piece of the present invention just as the user would normally open a screen door or glass door. Completely without any additional effort on the part of the user, the second piece of the present invention lifts up to become roughly parallel with the slope of a conventional entryway stairwell. Thus, the user has enough head clearance to ascend the conventional entryway stairwell, and pass through the entryway. In short, the part of a conventional screen door or glass door that would interfere with the lower than normal ceiling in the garage has been replaced with the second piece of the present invention.

### BRIEF DESCRIPTION OF THE DRAWINGS

FIG. 1 shows the present invention in a closed position.

FIG. 2 shows the present invention in a partially open position.

FIG. 3 shows the present invention in an open position.

### DETAILED DESCRIPTION OF THE PREFERRED EMBODIMENT(S)

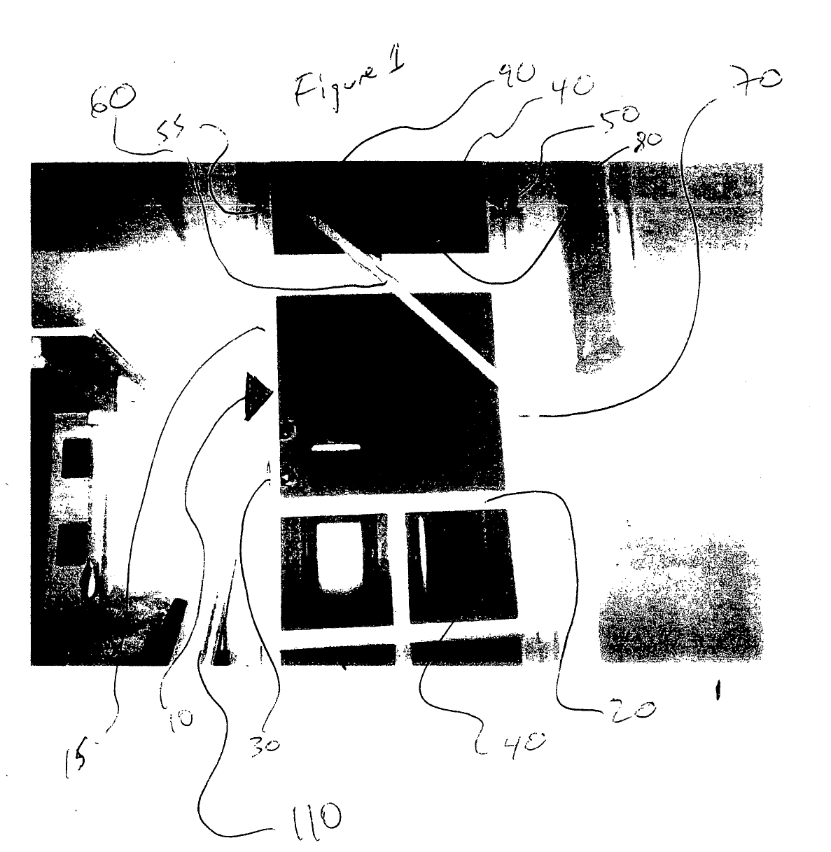

The present invention, as shown in FIG. 1, is in a closed position fitting flush with a conventional entryway. As will be hereinafter described, the present invention is designed to move from this closed position to a fully open position to allow a user to move to the entryway.

The first piece (10) of the present invention takes up the space that, approximately, the bottom ⅘ of a conventional screen or glass door would occupy. The first piece (10) can be constructed of any material for its first border (15), and any number of crossbars (20) and handles (30) can be employed. A conventional screen or glass insert (40) fits between first border (15) and crossbars (20).

The second piece (50) of the present invention takes up the space that, approximately, the top ⅕ of a conventional screen or glass door would occupy. The second piece (50) can be constructed of any material for its second border (55), and any number of crossbars (20) can be employed, or even no crossbars can be employed. A conventional screen or glass insert (40) fits within second border (55).

It should be noted that the first piece (10) and the second piece (50) are not required to be related to one another in any particular proportion, however, for ease of operation, the second piece (50) is generally smaller than the first piece (10) so that the weight of the second piece (50) is pulled as the lesser weight, as will be described later. The preferred dimensions of the present invention are as follows: first piece (10) is 61 inches high and 30 feet wide; second piece (50) is 18 inches high and 30 feet wide.

A crossbar (60) is fixedly attached to first piece (10) via any conventional method of attachment, preferably along first border (15). Cross bar (60) is fixedly attached at roughly a 45 degree angle from the doorjamb (70) and slopes upward from the doorjamb (70) to overlap second piece (50). Two conventional springs (80) are disposed between a first end (90) of crossbar (60) and the bottom of second piece (50). Held within two conventional springs (80) is safety cable (100). Although a single conventional spring could replace two conventional springs (80), the increased response to tension provided by two conventional springs (80) is more desirable than the tension provided by a single conventional spring. Preferably, two conventional springs (80) is actually two conventional 6 inch springs.

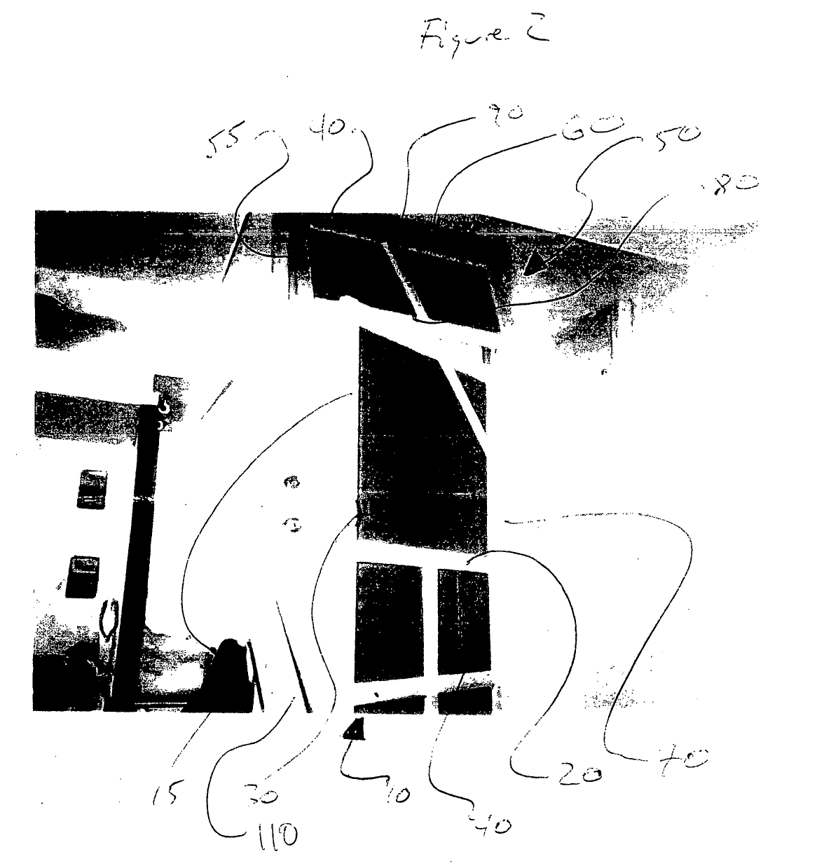

FIG. 2 shows the present invention partially opened away from the entryway. Of note is that first piece (10) has rotated about doorjamb (70) via conventional hinges, and in so doing, has pulled crossbar (60) away from second piece (50). As crossbar (60) moves away from second piece (50), two conventional springs (80) are pulled upon. Once sufficient tension is reached, two conventional springs (80) will left second piece (50) up, so that second piece (50) rotates slightly about the top of the entryway on conventional hinges.

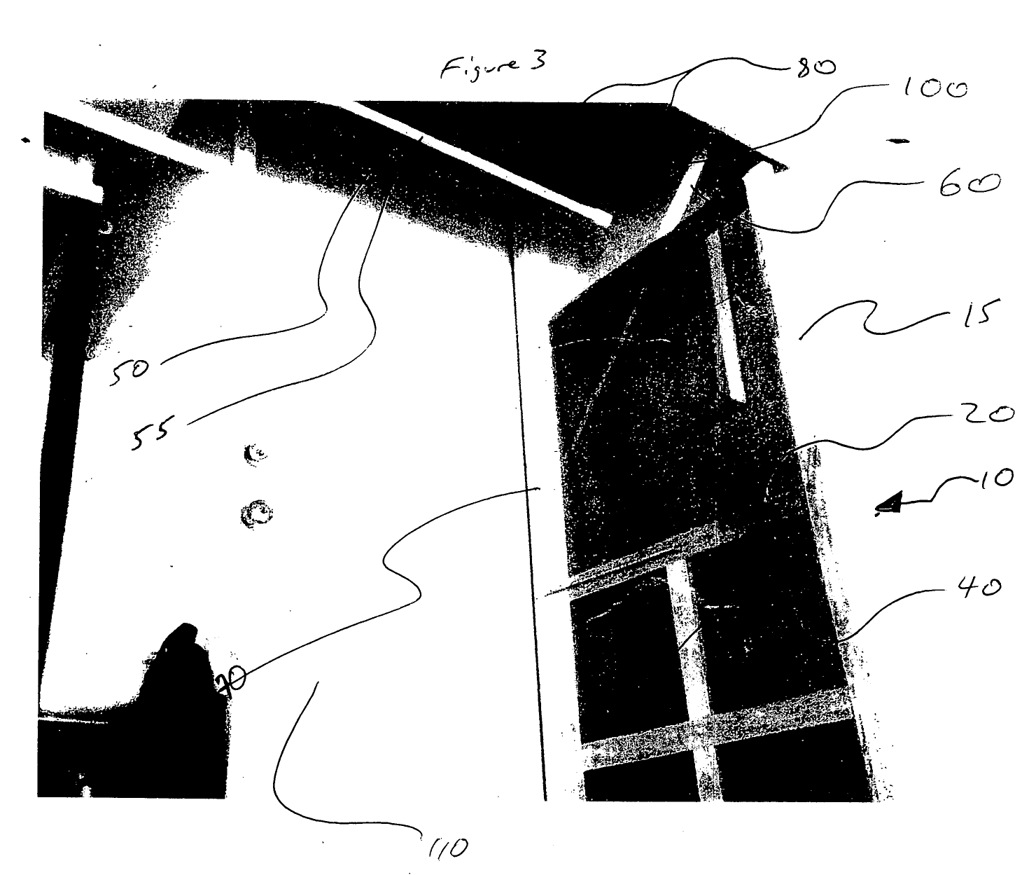

FIG. 3 shows the present invention completely opened away from the entryway. Of note is that first piece (10) has rotated nearly 90 degrees about doorjamb (70) via conventional hinges, and in so doing, has pulled crossbar (60) away from second piece (50). As crossbar (60) moves away from second piece (50), the two conventional springs (80) are pulled upon so greatly that sufficient tension is reached so that two conventional springs (80) lift second piece (50) well away from the entryway. In short, second piece (50) rotates well about the top of the entryway so that it rotates approximately 45 degrees from its original vertical position. Of special note is that second piece (50) is approximately parallel with conventional stair rail (110), and that means that as the user walks up the conventional stairs using conventional stair rail (110), the user will have sufficient clearance below second piece (55) to access the entryway. Alternative embodiments of the present invention provide for crossbar (60) to become vertical at its first end, rather than being a mere straight line. Such modifications are desirable to vary the distance by which second piece (50) is elevated in response to first piece (10) rotating about door jamb (70).

I claim:

1. A modified outer door, comprising:
a first piece, encompassing a majority of a door;
a second piece; encompassing the rest of the door, adjacent to said first piece;
crossbar, in fixed communication with said first piece; and
a resilient member, disposed between said crossbar and said second piece;
wherein said first piece cause said second piece to rotate about a horizontal axis as said first piece rotates about a vertical axis.

2. The outer door of claim 1, wherein said resilient member is at least one spring.

3. The outer door of claim 1, wherein said crossbar has a bend.

4. The outer door of claim 1, wherein said second piece rotates 45 degrees.

5. The outer door of claim 1, wherein said first piece rotates 90 degrees.

6. The outer door of claim 1, further comprising a safety cable in communication with said resilient member.

7. The outer door of claim 2, further comprising a safety cable held within said at least one spring.
